(19) United States
(12) Patent Application Publication
(10) Pub. No.: US 2018/0059883 A1
(43) Pub. Date: Mar. 1, 2018

(54) SYSTEM AND METHOD FOR PROVIDING A LEARNING ENVIRONMENT

(71) Applicant: Safe & Reliable Healthcare, LLC, Evergreen, CO (US)

(72) Inventors: Allan S. Frankel, Acton, MA (US); Michael W. Leonard, Evergreen, CO (US); Terri Christensen Frankel, Acton, MA (US); Joshua Proulx, Lehi, UT (US); Cynthia Schutt Malhinha, San Jose, CA (US); Daniel Joseph Cramer, Murray, UT (US); John D. Duce, Lehi, UT (US)

(21) Appl. No.: 15/686,092

(22) Filed: Aug. 24, 2017

Related U.S. Application Data
(60) Provisional application No. 62/379,181, filed on Aug. 24, 2016.
(60) Provisional application No. 62/505,068, filed on May 11, 2017.

(51) Int. Cl. G06F 3/0482; G06Q 10/06; G06Q 10/10

(52) U.S. Cl. CPC G06F 3/0482; G06Q 10/103; G06Q 10/06

(57) ABSTRACT

A digital learning environment method and system includes a display module that is configured to be divided into plural information areas, and plural input modules, connected to the display module, and configured to obtain user inputs. A processor is connected to the plural input modules and the display module, and is configured to receive and display in real-time, inputs from the users corresponding to the plural input modules. The processor is also configured to allow the users to collaborate in real-time.

### CROSS-REFERENCE TO RELATED APPLICATIONS

The present application claims the benefit under 35 U.S.C. §119(e) of the following two U.S. provisional patent applications: U.S. Provisional Patent Application Ser. No. 62/379,181, filed Aug. 24, 2016 for a LEARNING ENVIRONMENT SYSTEM AND METHOD; and U.S. Provisional Patent Application Ser. No. 62/505,068, filed May 11, 2017 for a LEARNING ENVIRONMENT SYSTEM AND METHOD, each of which are hereby incorporated by reference in their entirety for all purposes.

### INTRODUCTION

The application relates to systems that allow for communications between group members and, more particularly, to electronic systems that allow for those communications, especially within work environments, such as hospitals.

### SUMMARY

The present invention may be thought of as a digital learning board with a display that is sub-divided into multiple display fields. The digital learning board is also configured to receive input from other electronic devices so that multiple users can collaborate using their devices to access, add to, and edit information from the digital learning board.

According to an aspect of the invention, there is provided a learning environment system that includes a display module, plural input modules, a processor coupled to the display module and the plural input modules.

The display module is adapted to be divided into designated information areas. Each of the plural input modules has a corresponding user and is connected to the display module. Each input module is also adapted to enter information or obtain user inputs. The processor receives inputs from the plural input modules and is configured to display the information in real-time. Further, the processor is configured to allow the plural users to collaborate in real-time.

According to another aspect of the invention, there is provided a method for learning that includes receiving by a processor an input from plural input modules. Method further includes processing of the input received, by the processor and displaying, by the processor, the processed data on a display module from the plural input modules. The processed data includes information regarding anyone or a combination of identified issues, resolved issues or pending issues.

According to yet another aspect of the invention, there is provided a non-transitory computer-readable storage medium for a learning environment in a communication network, which when executed by a computing device cause the computing device to perform a method that includes the steps of receiving by a processor an input from plural input modules. Method further includes processing of the input received, by the processor and displaying, by the processor, the processed data on a display module from the plural input modules. The processed data includes information regarding anyone or a combination of identified issues, resolved issues or pending issues.

Additional features and advantages of the present invention are described in, and will be apparent from, the detailed description of the presently preferred embodiments and from the drawings.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Reference numerals designate corresponding parts throughout the several views.

FIG. 1 illustrates a system for learning, in accordance with an aspect of the invention.

FIG. 2 illustrates a processor and various modules of the system in FIG. 1.

FIG. 3A-3F illustrates various user interfaces of a display made by the system in FIG. 1.

FIG. 4 illustrates a user device of the system in FIG. 1.

FIG. 5 illustrates a method for providing a learning environment, in accordance with another aspect of the invention.

FIG. 6 illustrates a method for providing a learning environment, in accordance with another aspect of the invention.

FIG. 7 illustrates an exemplary computer environment, in accordance with an aspect of the invention.

### DETAILED DESCRIPTION

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

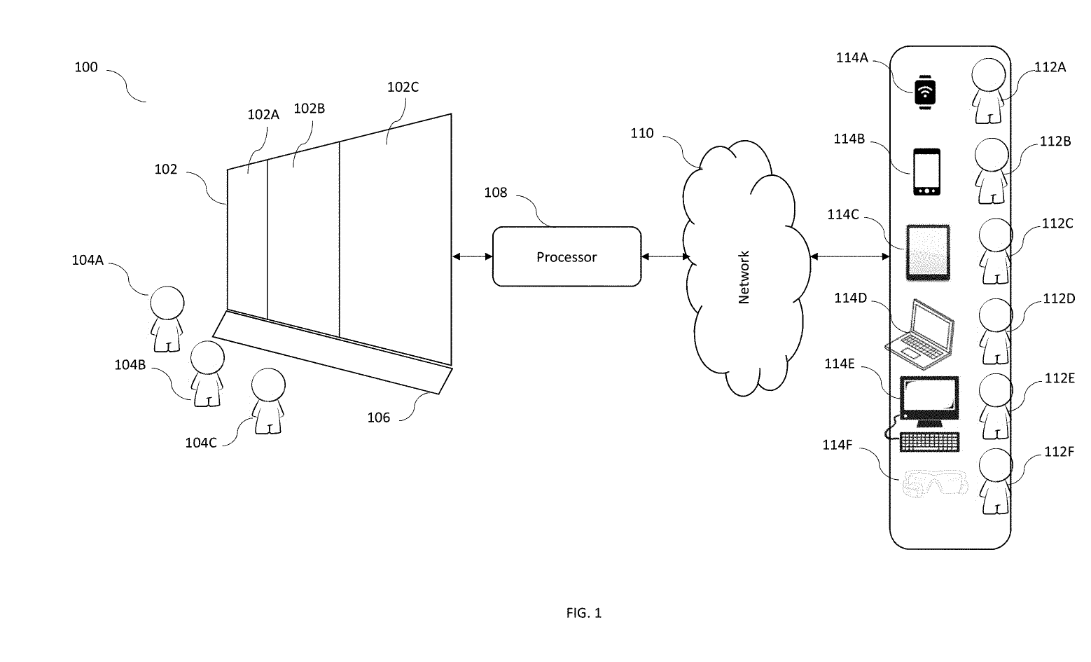

Now referring to FIG. 1 that illustrates a system 100 for the working of the invention, in accordance with an aspect of the invention. The system 100 includes a display module 102, a local input module 106, a processor 108 and a plural input modules 114A-114F (collectively referred to as input modules 114) coupled to each other via a network 110.

The display module 102 may further include multiple display areas 102A, 1026, or 102C. Different display areas may be configured to display different information. For e.g. 102A may display “New identified Issues” whereas 102B may display “Resolved Issues” and 102C may display “Pending Issues”. It may be appreciated by a person having ordinary skill in the art that the display 102 may be divided into further display areas or more than three display areas. The display 102 may be a Light emitting diode display (LED), a liquid crystal display (LCD), a plasma display, an Organic Light Emitting display (OLED), an Active Matrix Organic Light Emitting Display (AMOLED), or a cathode ray tube (CRT) display. The display module 102 may be made up of a single display board or multiple display boards may be combined together to make one single display.

The local input module 106 may be a keyboard, a stylus, a mouse or a touch screen interface, etc. the local input module may help the local users 104A-104C, those present within the vicinity of the display module 102, to enter or input information and access the information on display to just read the information.

The processor 108 may comprise at least one data processor for executing program components for executing user- or system-generated requests. The processor 108 may include a microprocessor, embedded or secure processors.

The network 108 may be a wired or a wireless network. The network 108 may be Local Area Network (LAN) that may be implemented using a TCP/IP network and may implement voice or multimedia over Internet Protocol (IP) using a Session Initiation Protocol (SIP). The processor 108 may be coupled to the display module 102 and the plural input modules 114 through a network interface module (not shown in figure). The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/ac/x, etc. The communication network 110 may include, without limitation, a direct interconnection, local area network (LAN), wide area network (WAN), wireless network (e.g., using Wireless Application Protocol), the Internet, etc. Using the network interface and the communication network 110, the processor 108 may communicate with the input modules 114. These input modules 114 may include, without limitation, personal computer(s), smart watches, tablet computer, desktop PCs, head mounted wearables, and various mobile devices such as cellular telephones, smartphones (e.g., Apple iPhone, Android-based phones, etc.) or the like. Each of the input modules 114 corresponds to at least one of plural remote users 112A-112F (collectively referred to as remote user 112).

In some embodiments, the processor 108 may be disposed in communication with one or more memory devices (not shown in figure) via a storage interface (also not shown in figure). The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The processor 108, receives inputs from the connected input modules 114. As described above, each of the input module corresponds to each of the users 112. Users may have various defined accessibility roles. Some users may have read access, some may have write access, and some may have both read and write access. The users 112 logon using their respective input modules 114. The users may add information through their respective input modules 114. This information, when received by the processor 108 through the network 110, analyzes the information and processes it to be displayed on the display module 102 on any of the display areas 102A, 102B, and 102C. The local users 104A, 104B, and 104C (collectively referred to as remote users 104) are those users who may be present at the vicinity of the display module 102. They may cumulatively logon to the system 100 using remote input module 106. Any information added by any type of user, be it local users 104 or remote users 112, is analyzed and processed by the processor 108 to be displayed on designated display areas 102A, 102B, and 102C.

The processor decides display areas based on the context of the information received or input received from the users 112, and 104. Also, the processor 108 enables usage of various collaborative tools like conference calls including audio and video conference calls, document sharing, document editing, document collaborating, etc. By way of an example the local users 104 who may be present near the display module 102 are able to collaborate or have a team huddle with the remote users 112. The remote users 112 thus may attend or collaborate in every team meeting or documents. Also, the remote users 112 and the local users 104 may be part of same team and may work together, even when not being present physically together, to identify key issues, problems, news, techniques etc.

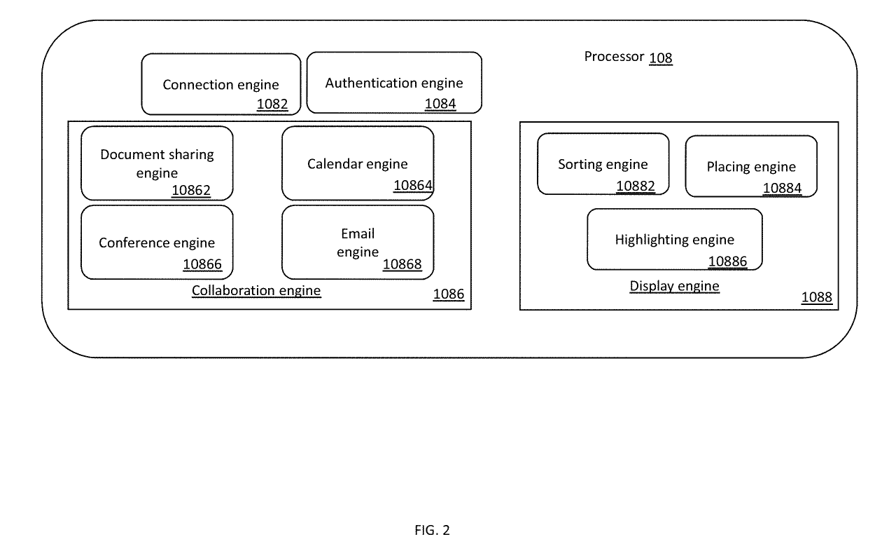

Now referring to FIG. 2 illustrating various modules of the processor 108, in accordance with an aspect of the invention. The processor 108 helps in collaboration of remote users 112 and local users 104 in the learning system 100. The processor 108 includes a connection engine 1082, an authentication engine 1084, a collaboration engine 1086, and a display engine 1088.

The connection engine 1082, acts as a network interface and helps in connecting to the network 110. The connection engine may be either a microprocessor or a combination of multiple processors. Microprocessors may be either hardware or software compilations.

The authentication engine 1084, connected to the connection engine 1082, helps in identification and authentication of user logging in. The authentication engine 1082 helps to keep a check on user access of the system 100. The authentication engine 1082 may be coupled to a memory or a database to store the authentication details and verify the same. Also, the database may include information like which user may be provided what kind of access. The access level may be based on user hierarchy, seniority, user type etc. The access may be read access, write access or a combination of both.

The collaboration engine 1086 helps users 112 and 104 to collaborate with each other. The collaboration engine 1086 may include a document sharing engine 10862, a calendar engine 10864, a conference engine 10866 and an email engine 10868.

The document sharing engine 10862 helps users to share and collaborate on various documents. The documents may be text files, images, videos, presentations spreadsheets, etc. the document sharing engine 10862 helps in identifying user who edits or accesses the document supported by time stamp of when the document was used. In this manner, the document sharing engine 10862 is configured to trace back to a user who makes changes or uses it and when.

Also, in case a user wrongly accesses a document, the document sharing engine may stop the user by providing a warning to the user on his respective device. For this functionality, the document sharing engine 10862 may be connected to the memory to access the document sharing permissions etc. In an implementation, the documents sharing engine may have its own cache memory for the same functioning. Sharing of documents may be done by providing access through either user IDs of the users or email addresses. Further, the documents sharing engine 10862 may have another setting of sharing a particular document with all users that is keep the document public. Documents shared may also include report of errors, or single error reported.

The calendar engine 10864, provides meeting possibilities to users 112 and 104. The calendar engine collaborates calendars of all users 112 and 104 and may initiate meeting sessions based on events found. The events may be calendar invites or calendar events received for a specific time and date. User who wants to have a meeting may send in calendar invites to other user desired on the meeting. When these users accept the invites, the events are added on the respective user's device calendar. When meeting time approaches, user is intimated about the same. In other implementation, the meeting may automatically start on specific time or in some buffer time.

The conference engine 10866 helps users 112 and 104 to have conference calls. The conference calls may be either audio calls, video calls or a combination thereof. Conference calls may be made by inviting participants using their email IDs or user IDs. The email engine 10868 may also help users 112 and 104 to have meetings initiated. It works similar to the calendar engine 10864. The email engine 10868 may be able to automatically pick up meeting request from mails received by a user. this may be done using a semantic analysis. Also, when a user sends a meeting invite, the email engine may automatically create a meeting event. Also, the email agent 10868 may be able to send reminders to invited users before the meeting event happens.

The display engine 1088 is responsible for displaying the right content at the right place at the right time. The display engine is coupled with the authentication engine 1084. The display engine receives data from users 112 and 104 after being authenticated and displays the same at right place on the display module 102. The display engine 1088 may include a sorting engine 10882, a placing engine 10884 and a highlighting engine 10886.

The sorting engine 10882 helps in sorting data received as per the content written. For example, the data from a user about an error is sorted out to be an error information. Hence, it may be tagged as an error information and sorted out to be placed on specific area “Issues identified” 102A. This may be done using a semantic analysis by the sorting engine 10882.

The placing engine 10884 decides positioning of the information received, as per the tag of the information sorted by the sorting engine 10882. The placing engine 10882 then may also display name of user adding information and time of the information received. For placing of the information, the placing engine 10884, may maintain a repository of tags and their placing on the display module 102, based on which placing of the text is performed.

The highlighting engine 10886 may be used by a user to highlight a certain severe pending issue or a rectified issue. Various types of highlighting colors may be used to convey different information. The highlighting engine 10886 may have this functionality specially to help users having read access only. In this manner, users with only read access may be able to convey information without editing the same.

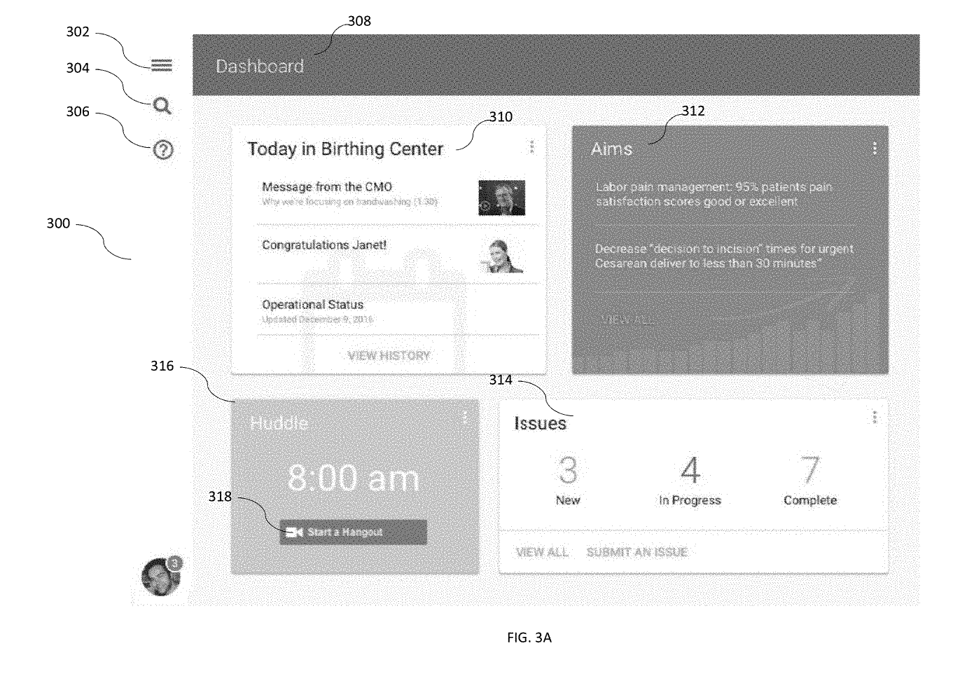

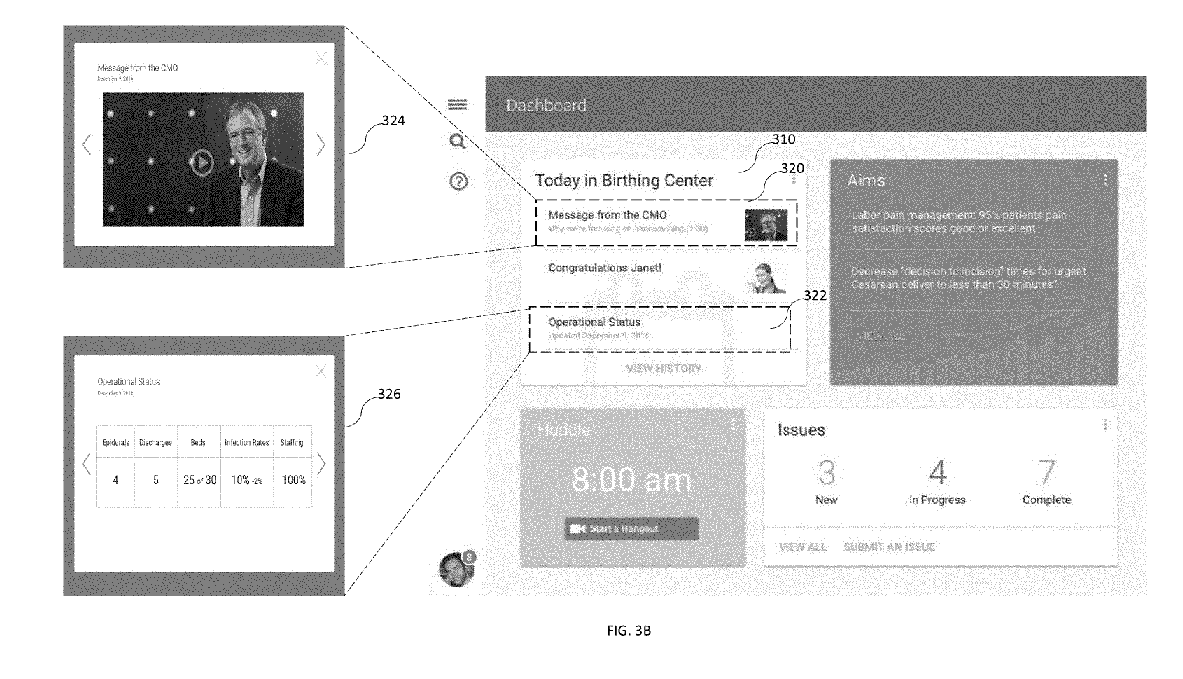

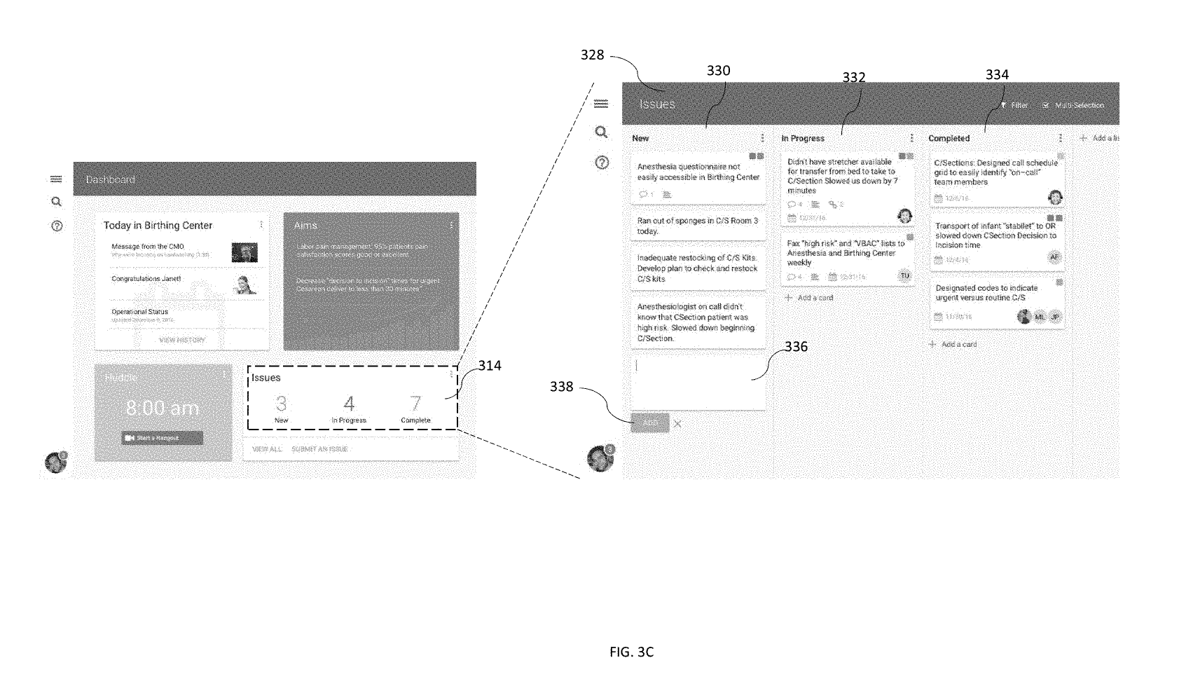

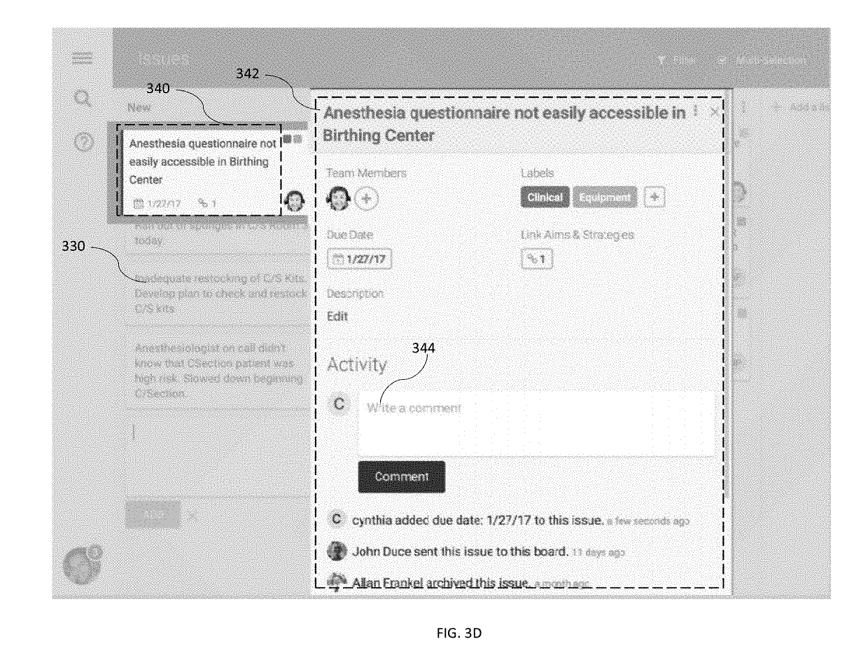

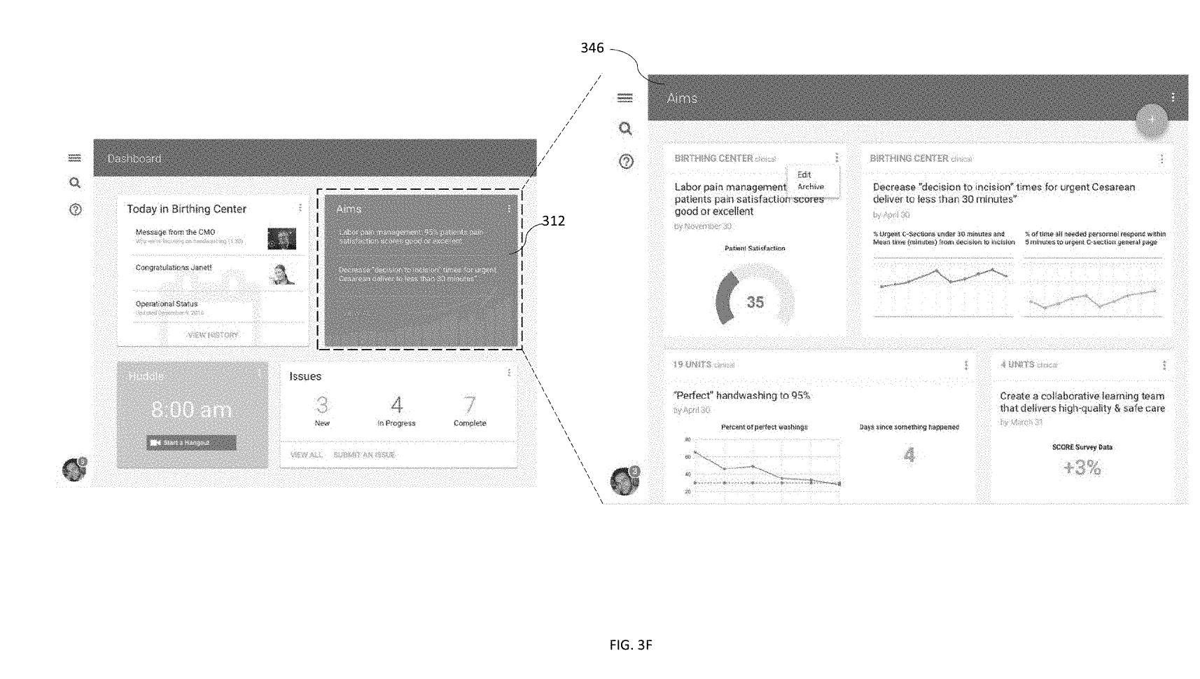

Now referring to FIG. 3A-3F, various user interfaces at various steps and level of information are illustrated, in accordance with as aspect of the invention. FIG. 3A depicts a user interface 300 after the user logs on to the system 100. The user interface 300 is similar to the display module 102 and will be referred interchangeably. The user interface 300 may depict a first landing page after user logs in. the user interface 300 may include a menu input 302. The menu input 302 may be used by a user to access various functions of the user interface 300. The user interface 300 may also include a search input tab 304. The search tab 304 may be utilized to search for various information like issues pending etc. Furthermore, the user interface may utilize a help tab 306. The help tab 306 may be utilized to help a user or explain user about various information about user interface 300.

Furthermore, the user interface 300 may include a dashboard 308 that may be further divided into multiple information areas to display multiple types of information. The user interface 300 may include a general information area 310, an aims area 312, and issues area 314. The general information area 310 provides general important information like “A message from the CEO”, or “operational status of a new wing” etc. This information may generally be information to public at large and not for some specific users. The aims area 312 helps providing information to users about specific aims that their organization is working towards. It may involve information about decreasing a particular type of a problem faced by users, and may get updated regularly or in real-time. The issues area 314 may contain information about new issues identified, in progress resolution of issues and also completely rectified issues.

The user interface 300, may also include an information input area 316 wherein a user may enter information of interest or use. For e.g., a user may input information about issues being faced in a process etc. which, after sorting by the sorting engine 10882, may display it in the issues section 314. The user interface may also include a tab to collaborate for e.g. 318 as a Google hangout tab. User can simply click on the tab 318 to initiate a meeting with the users invited or a general meeting with all users.

Now referring to FIG. 3B, there is shown second level information that is available to users accessing the general information area 310. A user may be able to access more information when he touches the messages on the general information area 310. For e.g., a user may touch a message 320 i.e. “A message from the CEO”, or message 322 i.e. “Operational status” to see more information about the same. The messages may open a pop-up window or a completely different window 324 and 326 respectively, to display additional information.

Similarly, as depicted in FIG. 3C, the user may touch the issues identified at 314. This input from the user may provide a new sub-user interface 328. The sub-user interface 328 may have further bifurcation of display area into multiple parts displaying New issues identified 330, In progress issues 332, and Completed issues 334 areas. User may add a new issue or in progress issue or completed issue information through an information addition area 336 and hitting a submit button 338. Further, the user may get into third level of information wherein, user going through the new issues identified area 330 may want to have more information about a message 340 as depicted in FIG. 3D. the user may give his/her input by touching the message 340 that may open a pop-up window 342 that may include an activity enter area 344 to add some notes about the message that may act as supporting information.

Referring to FIG. 3F, the user wanting to know about information in Aims area 312, may give their input by touching the area. This action may open up a new window 346 with full description of Aims area 312.

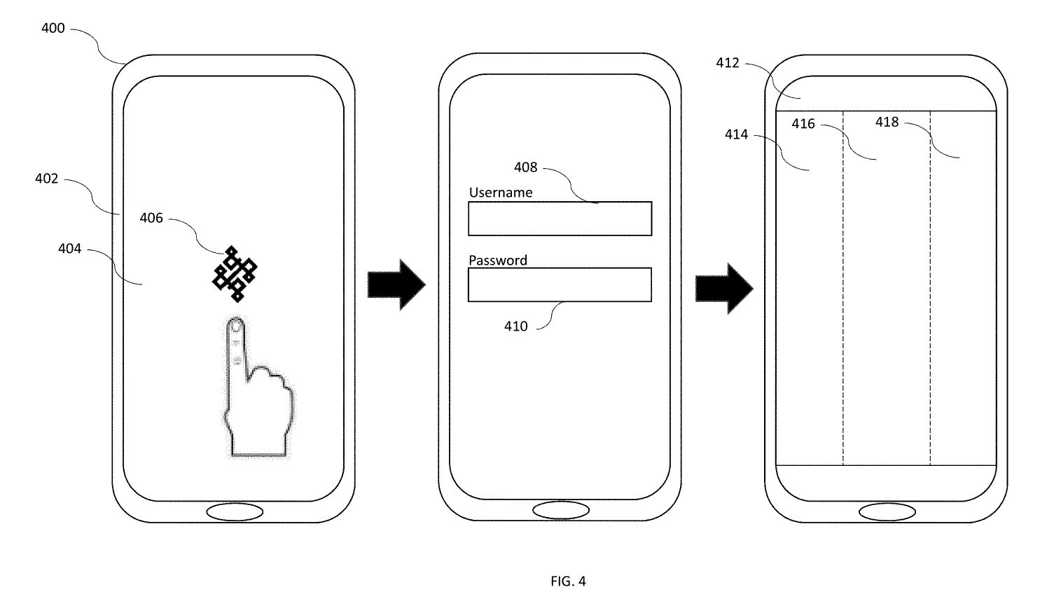

Referring to FIG. 4, a user interface 412, is provided on a user device 400 having a display frame 402 and a display unit 404. The user interface 412 may be accessed using a software application 406 provided on the user device 400. The software application may be initiated by user's touch input. After this input, the software application may display an authentication interface or login interface having a username field 408 and a password field 410. User may also be able to login using his other authentication details like fingerprint, or biometric scan or voice prints etc. After successful log in, user is displayed with the user interface 412 that may include multiple information display areas 414, 416 and 418.

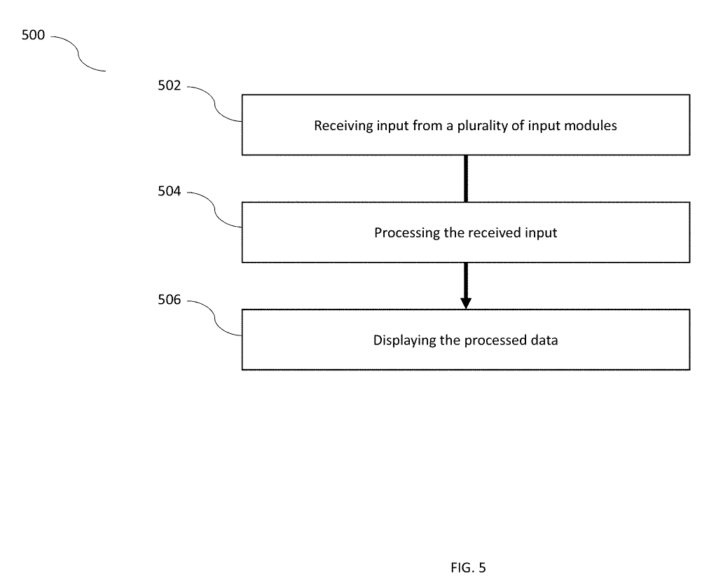

FIG. 5 illustrates a method 500 for learning in accordance with another aspect of the invention. At step 502, the processor 108, receives inputs from the input modules 114 corresponding to the plural users 112. As described, the input modules 114 may have the software application 406 which when activated by a user may authenticate the user by requesting the user of his username and password. The user may then input information which when received by the processor 108 is processed. The processing includes semantic analysis, and further analysis as to which part of the display module 102 should the information be displayed on is performed. Further, at step 506, the processed data is then displayed in the relevant part of the display module 102.

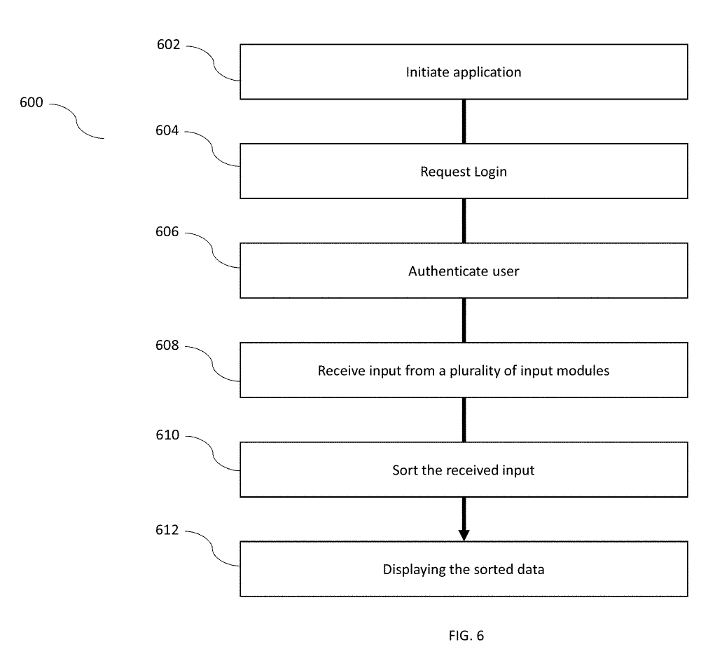

FIG. 6 illustrates a method 600 in accordance with another aspect of the invention. At step 602, user may initiate the application for connecting his input module to the display module 102. The application may be a software application embedded into the Operating Software or may be downloaded and installed via an application store. The application when initiated, at step 604, provides an authentication interface to the user. the user may enter his log in credentials to log in. Log in may be through a username password, or other log in credentials like fingerprint, biometric scans etc. At step 606, the processor 108 checks the log in credentials and verifies it from the memory or database. After successful login, at step 608, the processor receives input from the user and identifies the information being input. Further, at step 610, the processor sorts the data based on the context of the information added. The context may be extracted using semantic analysis. Further, at step 612, as per the sorted data, specific area of the display module 102 is identified wherein the data is to be displayed.

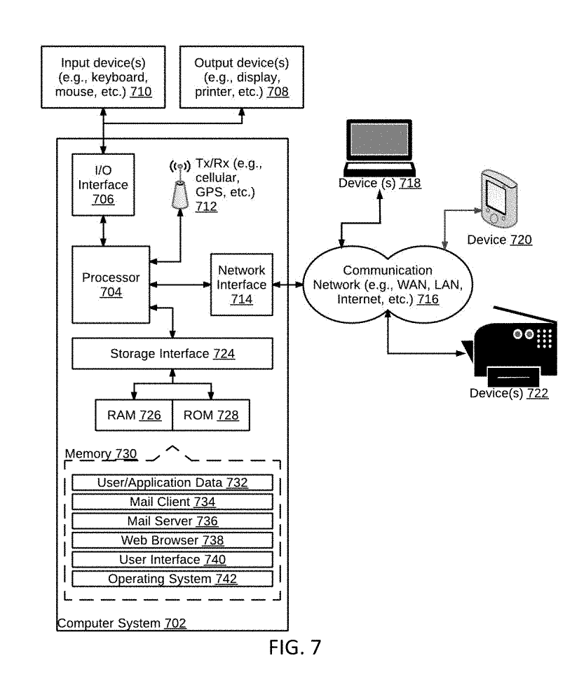

FIG. 7 illustrates an exemplary computer system 702 for implementing various embodiments of the invention. Computer system 702 may comprise a central processing unit (“CPU” or “processor”) 704. Processor 704 may comprise at least one data processor for executing program components for executing user- or system-generated requests. A user may include a person, a person using a device such as such as those included in this disclosure, or such a device itself. Processor 704 may include specialized processing units such as integrated system (bus) controllers, memory management control units, floating point units, graphics processing units, digital signal processing units, etc. Processor 704 may include a microprocessor, such as AMD Athlon or Sempron, Duron or Opteron, ARM's application, embedded or secure processors, IBM PowerPC, Intel's Core, Itanium, Xeon, Celeron or other line of processors, etc. Processor 704 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 704 may be disposed in communication with one or more input/output (I/O) devices via an I/O interface 706. I/O interface 706 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.11 a/b/g/n/ac/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 706, computer system 702 may communicate with one or more I/O devices. For example, an input device 708 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 710 may be a printer, fax machine, video display (e.g., cathode ray tube (CRT), liquid crystal display (LCD), light-emitting diode (LED), plasma, or the like), audio speaker, etc. In some embodiments, a transceiver 712 may be coupled to processor 704. Transceiver 712 may facilitate various types of wireless transmission or reception. For example, transceiver 712 may include an antenna operatively connected to a transceiver chip (e.g., Texas Instruments WiLink WL1283, Broadcom BCM4760IUB8, Infineon Technologies X-Gold 618-PMB9800, or the like), providing IEEE 802.11a/b/g/n/ac/x, Bluetooth, FM, global positioning system (GPS), 2G/3G HSDPA/HSUPA communications, etc.

In some embodiments, processor 704 may be disposed in communication with a communication network 714 via a network interface 716. Network interface 716 may communicate with communication network 714. Network interface 716 may employ connection protocols including, without limitation, direct connect, Ethernet (e.g., twisted pair 10/100/1000 Base T), transmission control protocol/internet protocol (TCP/IP), token ring, IEEE 802.11a/b/g/n/ac/x, etc. Communication network 714 may include, without limitation, a direct interconnection, local area network (LAN), wide area network (WAN), wireless network (e.g., using Wireless Application Protocol), the Internet, etc. Using network interface 716 and communication network 714, computer system 702 may communicate with devices 718, 720, and 722. These devices may include, without limitation, personal computer(s), server(s), fax machines, printers, scanners, various mobile devices such as cellular telephones, smartphones (e.g., Apple iPhone, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 602 may itself embody one or more of these devices.

In some embodiments, processor 704 may be disposed in communication with one or more memory devices (e.g., a RAM 726, a ROM 728, etc.) via a storage interface 724. Storage interface 724 may connect to memory devices 730 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory devices 730 may store a collection of program or database components, including, without limitation, an operating system 732, a user interface application 734, a web browser 736, a mail server 738, a mail client 740, a user/application data 742 (e.g., any data variables or data records discussed in this disclosure), etc. Operating system 732 may facilitate resource management and operation of computer system 702. Examples of operating system 732 include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8/10, etc.), Apple iOS, Google Android, or the like.

User interface 734 may facilitate display, execution, interaction, manipulation, or operation of program components through textual or graphical facilities. For example, user interfaces may provide computer interaction interface elements on a display system operatively connected to computer system 702, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, computer system 702 may implement web browser 736 stored program component. Web browser 736 may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, computer system 702 may implement mail server 738 stored program component. Mail server 738 may be an Internet mail server such as Microsoft Exchange, or the like. Mail server 738 may utilize facilities such as ASP, ActiveX, ANSI C++/C#, Microsoft .NET, CGI scripts, Java, JavaScript, PERL, PHP, Python, WebObjects, etc. Mail server 738 may utilize communication protocols such as internet message access protocol (IMAP), messaging application programming interface (MAPI), Microsoft Exchange, post office protocol (POP), simple mail transfer protocol (SMTP), or the like. In some embodiments, computer system 702 may implement mail client 740 stored program component. Mail client 740 may be a mail viewing application, such as Apple Mail, Microsoft Entourage, Microsoft Outlook, Mozilla Thunderbird, etc.

The above description has described embodiments of the invention with different functional units and processors. However, any suitable distribution of functionality between different functional units, processors or domains may be used without detracting from the invention. For example, functionality illustrated to be performed by separate processors or controllers may be performed by the same processor or controller. References to specific functional units are only intended as examples of suitable means or mechanisms for providing the described functionality, rather than being indicative of a strict logical or physical structure or organization.

Various embodiments of the invention provide systems and methods for enabling effective communications among several groups within an organization. One exemplary organization is a hospital, and using the system and method of the invention in that setting enables effective communication among various groups of healthcare service providers and administrators. The above described method enables generation of a personalized and contextual summary of a multimedia communication session that may also be thought of as a conference session or a webinar. The summary is generated based on individual needs, topics, roles, or participants by dynamically generating relevant meta-data along with content time stamp by using a semantic analyzer and a voice analyzer.

The specification has also described systems and methods for building contextual highlights for conferencing or communication systems. The illustrated steps are set out to explain the exemplary embodiments shown, and it should be anticipated that ongoing technological development may change how particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with the scope of invention being indicated by the following claims.

We claim:

1. A learning environment system comprising;
a display module, wherein the display module is configured to be divided into plural information areas;
plural input modules, connected to the display module, configured to obtain user inputs; and
a processor, connected to the plural input modules and the display module wherein the processor is configured to receive and display inputs from the users corresponding to the plural input modules in real-time, wherein the processor is further configured to allow the users to collaborate in real-time.

2. The learning environment system of claim 1, wherein the display module is a learning board.

3. The learning environment system of claim 2, wherein the plural information areas comprises identified issues area, active issues area, and a resolved issues area.

4. The learning environment system of claim 1, wherein the display module and the plural input modules are connected through a network.

5. The learning environment system of claim 4, wherein the network is anyone of a wired or a wireless network.

6. The learning environment system of claim 1, wherein the plural input modules is local or remote.

7. The learning environment system of claim 6, wherein the local input modules are anyone or a combination of a touch screen, a keyboard, or a mouse.

8. The learning environment system of claim 6, wherein the remote input modules are plural computing devices.

9. The learning environment of claim 8, wherein the plural computing devices are selected from a group comprising a mobile phone, a laptop, a tablet computer, a smart watch, a desktop computer, and a personal digital assistant.

10. The learning environment system of claim 9, wherein user interface displayed at display module is for displaying aggregated information.

11. The learning environment system of claim 10, wherein user interface of each of the plural computing devices displays information specific to a corresponding user from the plural users.

12. The learning environment system of claim 1, wherein the collaboration is anyone or a combination of a conference call, document sharing, task allotment, reminders, or emergency alerts.

13. The learning environment system of claim 10, wherein the conference call is an audio call, a video call or a combination thereof.

14. The learning environment system of claim 10, wherein the document sharing is private or public.

15. The learning environment system of claim 10, wherein the task allotment is public or private.

16. A method for learning comprising;
receiving, by a processor, an input from plural input modules;
processing, by the processor, the received input; and
displaying, by the processor, processed data on a display module from the plural input modules, wherein the processed data comprises information regarding anyone or a combination of identified issues, resolved issues, or pending issues.

17. The method of claim 16, wherein the plural input modules corresponds to plural users.

18. The method of claim 16, further comprises authenticating each user while providing input.

19. The method of claim 16, wherein the plural input modules is any one or a combination of a touch screen, a keyboard, a mouse, a mobile phone, a laptop, a tablet computer, a smart watch, a desktop computer, and a personal digital assistant.

20. A non-transitory computer-readable storage medium for a learning environment in a communication network, when executed by a computing device, cause the computing device to:
receive an input from plural input modules,
process the received input, and
display processed data on a display module from plural input modules, wherein the processed data comprises information regarding anyone or a combination of identified issues, resolved issues, or pending issues.
